(19) United States
(12) Patent Application Publication
(10) Pub. No.: US 2004/0088425 A1
(43) Pub. Date: May 6, 2004

(54) Application level gateway based on universal parser

(75) Inventors: Dmitry Rubinstein, Tel-Aviv (IL); Igor Genshaft, Givat-Shmuel (IL); Alexander Novoselsky, Tel-Aviv (IL); Joseph Gutin, Rosh-Ayin (IL)

Correspondence Address: SUGHRUE MION, PLLC, 2100 PENNSYLVANIA AVENUE, N.W., SUITE 800, WASHINGTON, DC, 20037, US

(73) Assignee: COMVERSE, LTD.

(21) Appl. No.: 10/284,320

(22) Filed: Oct. 31, 2002

(51) Int. Cl. G06F 15/16

(52) U.S. Cl. 709/230; 709/203; 709/246

(57) ABSTRACT

An Application Level Gateway (ALG) based on an universal parser, in a data transmission network. This ALG enables all data flow of an application level protocol to be checked for concordance with the formal syntax description of the data transmission protocol, and with a security policy. The ALG contains a transmission controller, universal parser, and at least one parser plug-in for each universal parser. This parser plug-in is specific to the data transmission protocol, and can be automatically created from the formal syntax description of a data transmission protocol. A security policy (rules, restrictions) can be implemented in the parser plug-in and/or in the settings.

### FIELD AND BACKGROUND OF THE INVENTION

1. Field of the Invention

The present invention relates generally to network communications, and in particular to safe transfer of information in a data network, to protect servers against possible attacks by malicious clients, to prevent unwanted information flow from a server in the event of server malfunction, and to enable protocol validation.

2. Description of the Related Art

Firewalls are an important part of typical modern communication networks. Firewalls protect the resources of inner networks during communication with systems located outside these networks. Firewalls can defend the inner networks from many types of attacks.

An Application Level Gateway (hereinafter referred to as “ALG”) is a special type of firewall. ALG operates at the application layer to process traffic through the firewall and can review not only message traffic, but also message content. Various types of ALGs are known. Examples of ALGs that are currently available, are “AppShield” from Sanctum, Inc. (Tasman Drive, Santa Clara, Calif. 95054, USA) and “SecurellS” from eEye Digital Security (One Columbia, Aliso Viejo, Calif. 92656, USA).

The “AppShield” ALG provides application layer security. This is achieved by automatically creating rules for legitimate behavior based on the HTML code within the page sent from the web server to the client. AppShield automatically identifies and remembers all of the acceptable responses defined in the HTML page. Only legitimate client responses are passed to the server. AppShield acts as a two-way proxy for HTTP/HTTPS protocols, and uses policy refinement rules for the client side scripting (JavaScript, VBScript etc.).

The SecurellS Application Firewall protects HTTP/HTTPS data flow. The SecurellS protects Microsoft IIS (Internet Information Services) web servers from attacks by verifying and analyzing incoming data for possible security threats before the data reaches the server. SecurellS uses CHAM (Common Hacking Attack Methods) technology, which gives SecurellS the capability to “understand” the web server protocol and also various classes of attack that web servers are vulnerable to.

Both the AppShield and SecurellS, however, protect only against attacks of malicious client based on HTTP/HTTPS protocols. These ALGs do not protect servers from attacks that are based on other protocols. Furthermore, SecurellS protection is currently limited to Microsoft IIS (Internet Information Services) Web servers 4.0 and 5.0.

An additional ALG is described in U.S. Pat. No. 6,311,278, assigned to Sanctum Ltd., which is fully incorporated herein by reference for all purposes as if fully set forth herein. In this patent, the gateway (filter module) is positioned between a server and client. The gateway parses the server messages to identify commands, fields etc., and stores this data in a protocol database. When the gateway receives requests from the client, it determines which requests are allowable by querying the protocol database. The gateway then eliminates any inappropriate or prohibited actions requested by the client to the server, and passes the remaining, permitted actions to the server.

This method, however, does not provide complete validation of communication protocol that would cover the full set of commands and responses by client and server according to a protocol description.

In addition, in the above-mentioned patent ('278) there is no check of server messages that are sent to the client. Accordingly, it is possible for incorrect server messages to be transferred to a client. Furthermore, there is no provision for the prevention of unwanted information flow from the server in the case of server malfunction.

Moreover, the process of obtaining the set of allowable commands from server messages is not necessarily accurate, since the code for parsing of server messages and identifying commands, fields etc., are created by a designer, and therefore may be incomplete or otherwise imperfect. In addition, the creation of such software is labor extensive and therefore expensive to develop. Finally, such ALG code is not reusable, and needs to be rewritten for each new communication protocol.

Another ALG system is described in Patent Application Number 00/16206 of WIPO, assigned to Perfecto Technologies Ltd., which is fully incorporated herein by reference for all purposes as if fully set forth herein. This patent application describes a gateway that is positioned between an external, non-secure computing environment and an internal, secure computing environment.

According to the patent application, the gateway performs a double conversion of messages, in order to verify the messages entering and exiting the gateway, as follows: received messages are converted into simplified messages, and simplified messages are converted into messages suitable for use in the internal environment (internal messages). Only internal messages are transmitted between internal and external environments.

Such double conversion, however, consumes a substantial amount of computer resources, and decreases the ALG throughput.

An additional patent application of relevance is Patent Application Number 01/31415 of WIPO, assigned to Sanctum Inc., which is fully incorporated herein by reference for all purposes as if fully set forth herein. This application describes a method and system for verifying a client request. The method includes receiving from a server a message that includes a set of actions, and simulating the execution of this set of actions in a proxy system environment. A list of allowable actions and allowable user input is defined based on the simulation. This list is then compared with the list of actual actions and inputs from a client. Only authorized client requests are passed to the server.

This method and system, however, require simulating the execution of client-side logic resulting in processing delays and consumption of computer resources.

### SUMMARY OF THE INVENTION

The present invention recognizes the need for, and the advantages of having an Application Level Gateway (ALG) that can check the data flow of an application level protocol according to the description of a data transmission protocol. The present invention recognizes that such an ALG should cover the full set of commands, requests and responses, according to the respective protocol description.

Furthermore the invention recognizes that it would be advantageous to have such a system wherein the setup costs and scalability costs are minimal, such that the required ALG adaptations for additional or alternative application level protocols are accomplished automatically.

According to the present invention there is provided a system and method for solving the problems attendant with the prior systems, in order to provide an efficient, reusable ALG architecture.

These objects are achieved by a preferred embodiment of the invention that incorporates the following components: a transmission controller, a universal parser, and a parser plug-in which is specific to the data transmission protocol, and can be automatically created for new protocols. The term “Data Transmission Protocol”, as described herein, incorporates various protocols, such as application level protocols.

A basic method according to a preferred embodiment is as follows:

1. Setting up an ALG so as to receive all client messages before the messages reach a server, and in addition, to receive all server messages before they reach a client.

2. Configuring the ALG with a universal parser and a parser plug-in, to process the data flow of a transmission protocol, according to defined rules.

3. A client makes a request, using a data transmission protocol.

4. The ALG intercepts the request and parses it completely in order to analyze its content and verify the request in relation to the ALG rules.

5.1. In the case where the request has been verified (i.e. the request is permitted because it corresponds to the ALG rules), the ALG sends this request to the server.

5.2. In the case where the request is not permitted (i.e., the request does not correspond to the ALG rules), the ALG does not send this request to the server, and records the information about the failed request in a report file.

6. In the case where the request is sent to the server, the server processes the client request and sends the response.

7. The ALG intercepts the server response, parses it completely in order to analyze its content, and thereafter verifies the response.

8.1. In the case where the response is permitted, (i.e. it corresponds to the ALG rules), the ALG sends this response to the client.

8.2. In the case where the response is prohibited (i.e., it does not correspond to the ALG rules), the ALG blocks this response to the client and records the information about the failed response in a report file.

By executing the above-mentioned method, all data flow of a transmission protocol, such as an application level protocol (e.g. client requests and server responses of HTTP or IMAP4 protocols), is checked for concordance with the formal syntax description of the data transmission protocol and with the particular security policy.

Another embodiment of the present invention provides a system and method wherein a plurality of universal parsers, each with at least one parser plug-in, are coupled to the transmission controller, so that the universal parsers are chained to the data flow pipeline. In this embodiment, each parser can be implemented to process a different part of the data flow or implement a different rule, syntax or policy.

Another embodiment of the present invention provides a system and method wherein a parser plug-in, which is specific to a data transmission protocol, is created automatically from the formal syntax description of the data transmission protocol. An example of this automatic process is in the case where the formal syntax description of a data transmission protocol is transformed by a software tool to an executable component (plug-in) for the universal parser.

Another embodiment of the present invention provides a system and method wherein if the data transmission protocol allows the transmission of executable software modules or script text (e.g. scripts on programming languages JavaScript and VBScript in HTML pages in HTTP protocol), there is a possibility to recognize and prohibit this transmission.

A further embodiment of the present invention provides a system and method wherein if the data transmission protocol allows the transmission of executable software modules or script text, this executable file or script text is checked for the presence of malicious code.

Since the present invention is based on a universal parser with a relevant plug-in, it can protect data from being transferred between servers and clients using any data transfer protocol. Moreover, the system's design enables scalability and easy (automatic) expansion for new protocols and security policies.

### BRIEF DESCRIPTION OF THE DRAWINGS

The present invention is herein described, by way of example only, with reference to the accompanying drawings, wherein:

FIG. 1 is a block diagram of a sample network with a client, an ALG (with one universal parser) and a server.

FIG. 2 is a block diagram of a simplex system with a sender, an ALG (with one universal parser) and a receiver.

FIG. 3 is a block diagram of a sample network with a client, an ALG (with three universal parsers) and a server.

### DESCRIPTION OF THE PREFERRED EMBODIMENTS

One embodiment of the present invention relates to a system and method for providing an efficient, reusable Application Level Gateway (ALG) architecture.

Specifically, this embodiment can be used to verify data flow of a data transmission protocol at the application level (for example, all client requests and server responses of HTTP or IMAP4 protocols), between a server and client. The ALG enables data flow of a transmission protocol, such as an application level protocol, to be checked for concordance with the formal syntax description of the data transmission protocol and with the relevant security policy. Furthermore, the ALG can be used to check the data flow of a plurality of transmission protocols with minimal adaptation required for each new protocol. As such, the ALG architecture is scalable and/or reusable.

The following description is presented to enable one of ordinary skill in the art to make and use a preferred embodiment of the invention as provided in the context of a particular application and its requirements. Various modifications to the preferred embodiment will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed.

The principles and operation of a system and a method according to the present invention may be better understood with reference to the drawings and the accompanying description, it being understood that these drawings are given for illustrative purposes only and are not meant to be limiting, wherein:

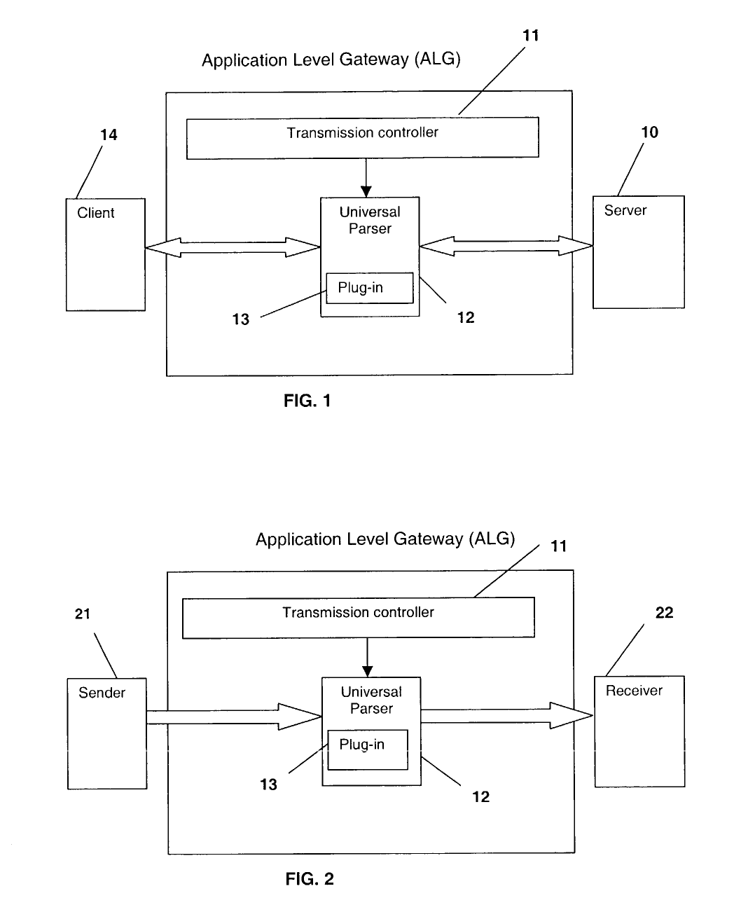

As can be seen in FIG. 1, the ALG according to a particular embodiment of the present invention incorporates a transmission controller 11, a universal parser 12, and a parser plug-in 13, which is specific to the data transmission protocol. These are described below in more detail. The ALG can be stored on a server, or on a computer(s) connected to the server.

i. The transmission controller 11 manages the connection between the client and server, and controls the data transmission and the operation of the universal parser. The transmission controller 11, more specifically, controls the data flow in the system, receives the incoming data and transmits the outgoing data.

ii. The Universal Parser 12 performs full parsing of incoming data to and outgoing data from the ALG, as is known in the art and together with the parser plug-in, checks all data flow for concordance with the formal syntax description of the data transmission protocol. Parsing is well known in the art (see, for example, Philip M. Lewis 2nd, Daniel J. Rosenkrantz, Richard E. Stearns, “Compiler Design Theory”. Addison-Wesley, 1976, incorporated herein by reference). Parsing is used in compilers of programming language and other applications, which divide an input data flow into components, called tokens, for comprehensive checking, analysis, transformation etc. Usually a parser performs two main tasks: (1) lexical analysis (i.e., scans the stream of characters and groups them into tokens) and (2) syntax analysis (i.e., checks the sequence of tokens for concordance with the syntax description). The universal parser 12 according to this embodiment of the invention acts like a compiler of programming language, which checks a source text of software for concordance with the syntax description of programming language and for error absence. According to this embodiment, the universal parser 12 contains the formal syntax description of a particular protocol. By checking data flow relative to the formal syntax description of the protocol, the present invention is able to “understand” data transfer protocol in detail thereby effectively verifying the data transmission protocol and any incoming or outgoing data using the protocol. The universal parser 12 divides the data flow into tokens, and compares each obtained token with the syntax description of the protocol. The plug-in module 13 contains all needed information for lexical and syntax analysis for the specific data transmission protocol.

The parser 12 of this embodiment is referred to as “universal”, because it can be adapted to usage with any data transmission protocol by adding an appropriate parser plug-in 13, and thereby not requiring changing of the parser itself. This methodology is vastly easier to apply than re-programming the parser for each new protocol requiring verification. The separation of the parser from the plug-in therefore enables such universal functioning.

iii. The parser plug-in 13 enables checking of the sequences of lexical units or tokens (i.e., groups of characters), obtained from the universal parser 12, for concordance with the formal syntax description of a data transmission protocol. A series of tokens must satisfy the expressed syntactic rules of a language (formal syntax description). The parser plug-in verifies the actual formal syntax description of the data transmission protocol by comparing the parsed lexical units from the universal parser with the formal syntax description of the protocol. This process enables the universal parser to determine legitimate client requests.

iv. A graphic user interface (GUI) can be used to provide control over the ALG, by an administrator.

Reporting on ALG actions (rejected and passed client requests etc.) can be provided for possible follow-up, audit, analysis etc. by software tools or by the ALG itself. The ALG can employ common formats for the report files, such as, e.g. Common Log Format (CLF), Extended Common Log Format (ECLF) etc.

In order to process new or alternative data transmission protocols, the ALG requires only an additional parser plug-in 13. No additional design or re-programming of the parser is required for this purpose. For example, if an administrator wanted to change the ALG protocol from POP3 to IMAP4, then the administrator would only need to switch the POP3 plug-in module to the IMAP4 plug-in.

According to a preferred embodiment of the present invention, all data flow of an application level protocol (e.g. client requests and server responses of HTTP or IMAP4 protocols) is checked by the ALG for concordance with formal syntax descriptions of the data transmission protocol and the security policy being used. The formal syntax description of such a protocol can be expressed using the Augmented Backus-Naur Form (ABNF) notation or any other notation for similar purposes (see Crocker, D., and Overell, P. “Augmented BNF for Syntax Specifications: ABNF”, RFC 2234, November 1997, incorporated herein by reference).

The security policy that has been determined can be presented to the ALG as set of rules and restrictions etc. Such security restrictions can include limitations of maximum length of password (to prevent, for example, buffer overflow), maximum number of login tries etc. Security rules can be action(s) of the ALG in response to restriction violations. The ALG checks the data flow to ensure that it matches the security policy. For example, a security policy can be expressed in security settings (e.g. parser finds a password in the data flow, and the password can not be longer than 512 bytes in length).

The ABNF notation, which is fully incorporated herein by reference, as if fully set forth herein, is a formal metasyntax used to express context-free grammars, and is one of the most commonly used metasyntactic notations for specifying the syntax of programming languages, command sets, and the like. This notation enables the generic expressing of data protocols in such a way that they can be understood and processed by a parsing device such as the universal parser of the present invention. The usage of the ABNF notation, according to the present invention, is described below.

The method for checking all data flow of a data transmission protocol, according to the present invention, includes full parsing of data flow, in both directions, between a server 10 and a client 14, by a universal parser 12.

The universal parser 12 works in an asynchronous (i.e., not at predetermined or regular intervals), stream-driven mode, such that it is not an active agent, requesting input. Instead, it processes the input in a passive mode, according to the order of acceptance of the input.

According to a preferred embodiment of the present invention, the parser and parser plug-in are separated. This separation of the universal parser 12 and parser plug-in 13, which is specific to the data transmission protocol, enables the ALG architecture to be reusable, since new protocol implementation requires only creating a new parser plug-in, and no changes are required to be made to the actual parser software. The plug-in contains elements and rules required in order for the ALG to parse and process the new protocol, thereby relieving the parser software redesign from this task. The only requirement is the provision of a parser plug-in, which is specific to the data transmission protocol.

In order to achieve the coverage of the full set of commands and responses, according to a protocol description, a parser plug-in 13 can be automatically created from the formal syntax description of a data transmission protocol. For example, the formal syntax description of a data transmission protocol is transformed by a software tool to an executable component (plug-in) for the universal parser.

One possible variant of the software tool that can be used transforms the text file of the formal syntax description, to the source texts of the parser plug-in, which are written in programming language C++ [see e.g. The C Programming Language, Second Edition by Brian W. Kernighan and Dennis M. Ritchie. Prentice Hall, Inc., 1988. ISBN 0-13-110362-8; Standard “Information Technology—Programming Languages—C++”, INCITS/ISO/IEC 14882-1998]. The source texts of the parser plug-in are then compiled by a C++ compiler, to an executable component.

Furthermore, if the data transmission protocol allows the transmission of executable software modules or script text (e.g. scripts on programming languages JavaScript and VBScript in HTML pages in HTTP protocol), the ALG can recognize such transmissions and optionally prohibit them. For example, in HTML pages the Java applets, texts of VBScript and JavaScript have specific tags by which they can be recognized, and where necessary, removed.

In addition, if the data transmission protocol allows the transmission of executable software modules or script text, this executable file or script text can be checked for the presence of malicious code. In this case, the ALG works like an anti-virus system. Alternatively, the ALG refers the request to an external anti-virus system.

The ALG can be a 2-way duplex system (for example, the client-server system in FIG. 1) or a 1-way simplex system, as can be seen in FIG. 2. As a 1-way simplex system, the ALG can secure data transfer in one direction only, from the sender 21 to the receiver 22. As a 2-way duplex system, the ALG can secure data transfer between the client 14 and server 10 in both directions (as in FIG. 1).

An administration and a Graphic User Interface (GUI) can be used by an administrator for control, configuration and customization of the ALG.

The Process

The configuration and operation of the ALG based on a universal parser is described below:

1. An ALG is setup in a communications network so as to receive all client requests before the requests reach a server, and in addition to receive all server responses before they reach the client.

2. A universal parser with a plug-in is configured within the ALG, to process the transmission protocol data flow according to defined rules.

3. A client makes a request, using a data transmission protocol.

4. The ALG intercepts the request, and parses it completely, in order to analyze its content in accordance with the formal syntax description, rules and restrictions of the transmission protocol and security policy, as reflected by the parser plug-in.

5.1. In the case where the request is verified in relation to the rules of the parser plug-in (i.e. the request is appropriate or permitted), the ALG sends this request to the server.

5.2. In the case where the request is prohibited, the ALG does not send this request to the server, and can record the information about the failed request in a report file. This report file can be used for later analysis by an ALG administrator to determine, for example, the type of malicious request.

6. In the case where the request is sent to the server, the server processes the client request and sends the response.

7. The ALG intercepts the server response, parses it completely in order to analyze its content, in accordance with the formal syntax description, rules, restrictions etc., as reflected by the parser plug-in, in order to verify the response.

8.1. In the case where the response is made appropriately, the ALG sends this response to the client.

8.2. In the case where the response is not made appropriately, the ALG does not send this response to the client and records the information about the failed response in a report file.

Alternate Embodiments

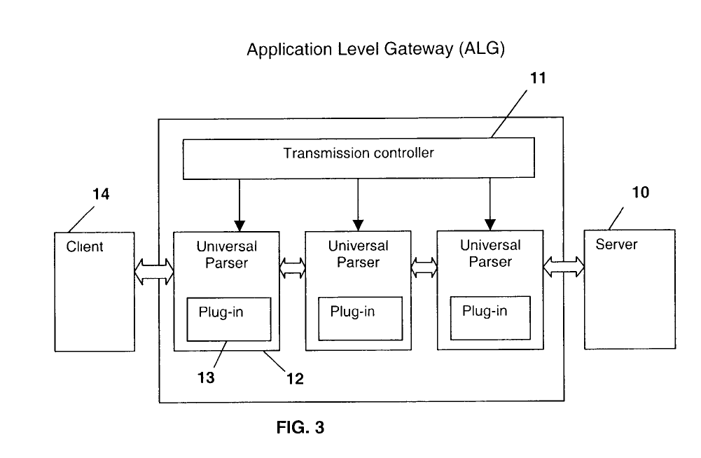

In an additional embodiment of the present invention, more than one universal parser can be coupled to the transmission controller 11 so that a plurality of universal parsers are chained to the data flow pipeline. This architecture, as can be seen in FIG. 3, enables increased reusability and flexibility of the ALG.

The foregoing description of the embodiments of the invention has been presented for the purposes of illustration and description. It is not intended to be exhaustive or to limit the invention to the precise form disclosed. It should be appreciated that many modifications and variations are possible in light of the above teaching. It is intended that the scope of the invention be limited not by this detailed description, but rather by the claims appended hereto.

What is claimed is:

1. An Application Level Gateway (ALG) for providing protocol validation in a data transmission network, comprising:
a) a transmission controller for controlling data flow between the ALG, a server and a client;
b) a universal parser coupled to said transmission controller, for parsing all data flowing between said server and said client, and through the ALG; and
c) a parser plug-in, connected to said universal parser, said plug-in containing a formal syntax description of a predetermined data transmission protocol; said ALG is operable for providing protocol validation by comparing the parsed data with the formal syntax description of the predetermined data transmission protocol contained in said plug-in.

2. The ALG according to claim 1, wherein there is a plurality of universal parsers coupled to said transmission controller, such that the universal parsers are chained to a data flow between said server and said client.

3. The ALG according to claim 1, wherein said universal parser recognizes transmission of an executable software module and is operable to prohibit said transmission.

4. The ALG according to claim 1, wherein said universal parser recognizes transmission of script text and is operable to prohibit said transmission.

5. The ALG according to claim 3, wherein said universal parser checks said transmitted executable software module for the presence of malicious code.

6. The ALG according to claim 4, wherein said universal parser checks said transmitted script text for the presence of malicious code.

7. The ALG according to claim 1, wherein said parser plug-in is created from a formal syntax description of a data transmission protocol.

8. A method for enabling an Application Level Gateway (ALG) to validate protocols in a data transmission network, comprising:
i. providing an ALG between a server and a client in the network;
ii. configuring a universal parser and a parser plug-in in said ALG, for analyzing data flow of an application level protocol through said ALG, said parser plug-in containing a formal description of said data transfer protocol; and
iii. validating said data flow of application level protocol, by comparing data flowing through said ALG for compatibility with the formal syntax description of said data transmission protocol.

9. The method according to claim 8, wherein validating of data flow further includes validating data flow for compatibility with a security policy.

10. The method according to claim 8, wherein said plug-in is created according to a formal syntax description of said data transmission protocol by transformation of said description to an executable module.

11. The method according to claim 8, wherein said plug-in is created according to a relevant security policy of an application level protocol by transformation of said description of said security policy to an executable module.

12. An Application Level Gateway (ALG) for providing protocol validation in a one-way simplex data transmission network, comprising:
a) a transmission controller for controlling data flow between a sender, the ALG and a receiver;
b) a universal parser coupled to said transmission controller, for parsing all data flowing between said sender and said receiver, and through the ALG; and
c) a parser plug-in, connected to said universal parser, said plug-in containing a formal syntax description of a predetermined data transmission protocol; said ALG is operable for providing protocol validation by comparing the parsed data with the formal syntax description of the predetermined data transmission protocol.

13. An Application Level Gateway (ALG) for providing protocol validation in a data transmission network, comprising:
a) a transmission controller for controlling data flow between the ALG and a server;
b) a universal parser coupled to said transmission controller, for parsing all data flowing between the ALG and said server; and
c) a parser plug-in, connected to said universal parser, said plug-in containing a formal syntax description of a predetermined data transmission protocol, said ALG is operable for providing protocol validation by comparing the parsed data with the formal syntax description of the predetermined data transmission protocol.

14. An Application Level Gateway (ALG) for providing protocol validation in a data transmission network, comprising:
a) a transmission controller for controlling data flow between the ALG and a client;
b) a universal parser coupled to said transmission controller, for parsing all data flowing between the ALG and said client; and
c) a parser plug-in, connected to said universal parser, said plug-in containing a formal syntax description of a predetermined data transmission protocol, said ALG is operable for providing protocol validation by comparing the parsed data with the formal syntax description of the predetermined data transmission protocol.

15. A method for providing validation of a predetermined protocol in an ALG, comprising:
parsing data flowing through the ALG;
determining compatibiliy with the predetermined protocol by comparing the parsed data with a pluggable format syntax description of the predetermined protocol.

16. The method of claim 15, further comprising:
prohibiting the data from flowing from the ALG if the parsed data is determined not to be compatible with the predetermined protocol.

17. The method of claim 16, wherein the ALG is provided between a server and a client.

18. The method of claim 15, wherein a data path exists between a server and a client and through the ALG.

19. A system for validating a response from a client computer, relative to a request from a server computer, the system comprising:
an Application Level Gateway (ALG) configured to parse the client response, compare the parsed response with a plug-in module containing a syntax description of a predetermined protocol, and based on the comparison ascertain whether the client response is valid with respect to the predetermined protocol.

20. The system of claim 19, wherein the ALG is further configured such that if the client response is not valid, then the ALG prohibits transmission of the client response from the ALG.

21. A system for validating an output from a server computer, the system comprising:
an Application Level Gateway (ALG) configured to parse the server output, compare the server output with a plug-in module containing a syntax description of a predetermined protocol, and based on the comparison ascertain whether the server output is valid with respect to the predetermined protocol.

22. The system of claim 21, wherein the ALG is further configured such that if the server output is not valid, then the ALG prohibits transmission of the server output from the ALG.
